(19) United States
(12) Patent Application Publication
(10) Pub. No.: US 2012/0171399 A1
(43) Pub. Date: Jul. 5, 2012

(54) HOUSING AND METHOD FOR MANUFACTURING THE SAME

(75) Inventors: LI-CHI PAI, Tu-Cheng (TW); CHANG-CHIN WU, Tu-Cheng (TW)

(73) Assignee: HON HAI PRECISION INDUSTRY CO., LTD., Tu-Cheng (TW)

(21) Appl. No.: 13/185,308

(22) Filed: Jul. 18, 2011

(30) Foreign Application Priority Data
Dec. 30, 2010 (TW) 99146776

(51) Int. Cl. B32B 1/02; B05D 5/00; C08J 7/04; B32B 33/00

(52) U.S. Cl. 428/35.7; 428/34.1; 427/258; 427/553; 427/511

(57) ABSTRACT

A housing includes a base layer, a primer layer formed on the base layer, an ink jet coating layer formed on the primer layer, and a protection layer formed on the ink jet coating layer. A method for manufacturing the housing is also provided.

### BACKGROUND

1. Technical Field

The present disclosure relates to housings, particularly to a housing having a coating and a method for manufacturing the housing.

2. Description of Related Art

To make the electronic devices more aesthetically appealing to users, the housings of the portable electronic devices may be decorated to have colorful appearances.

A colored coating layer is often formed on an outer surface of the housing of the electronic device by spraying. However, it is difficult to control the thickness of the colored coating layer during spraying. This may result in a non-uniform film thickness and affect the outer appearances or the yield of the housing of the electronic device. In addition, spraying only forms a single color on the outer surface of the housing, and it is difficult to form a patterned or a multi-color layer on the outer surface of the housing by spraying.

Therefore, there is room for improvement in the art.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the housing. Moreover, in the drawings like reference numerals designate corresponding parts throughout the several views. Wherever possible, the same reference numerals are used throughout the drawings to refer to the same or like elements of an embodiment.

FIG. 1 is a cross-sectional view of an embodiment of a housing.

FIG. 2 is a flowchart of an embodiment of a method for manufacturing the housing in FIG. 1.

### DETAILED DESCRIPTION

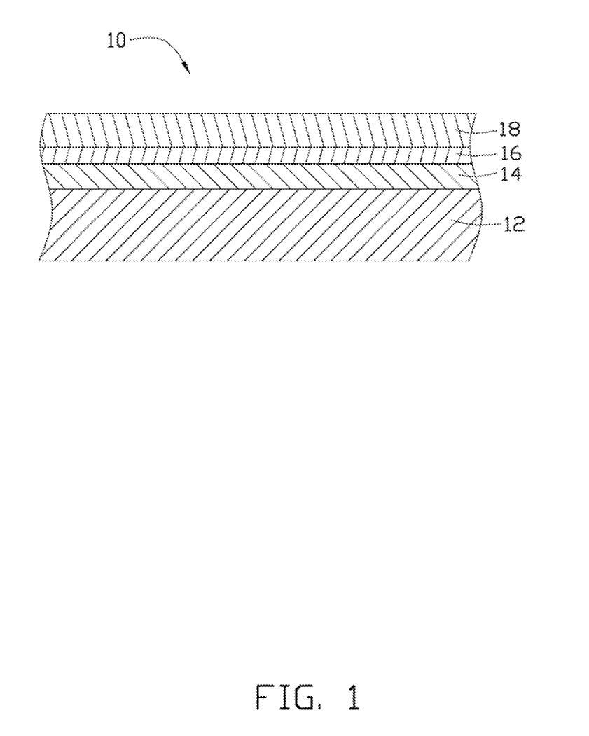

Referring to FIG. 1, an embodiment of a housing 10 includes a base layer 12, a primer layer 14, an ink jet coating layer 16, and a protection layer 18. The primer layer 14, the ink jet coating layer 16, and the protection layer 18 are coated on the base layer 12 in that order. A thickness of the primer layer 14 is in a range from about 1 μm to about 25 μm. A thickness of the ink jet coating layer 16 is less than 15 μm. A thickness of the protection layer 18 is in a range from about 1 μm to about 35 μm.

The base layer 12 can be made of aluminum alloy, magnesium alloy, titanium alloy, or any other suitable alloys. In alternative embodiments, the base layer 12 can be polymeric materials, such as polyvinyl chloride, polyethylene terephthalate, acrylonitrile-butadiene-styrene copolymer, polycarbonate, polyimide, multi-hydroxyl polymer, amine polymer, epoxy-based polymer, polyetherimide, polyphenylene sulfide, poly sulfone, polyvinyl propylene, polystyrene, polyethylene glycol modified polyester, polypropylene copolymer or any suitable combination thereof.

In the illustrated embodiment, the primer layer 14 is a silver paint layer formed on the base layer 12 by spraying via a spray gun. The primer layer 14 is solidified by thermal curing reaction. A thickness of the primer layer 14 is preferably in the range from about 15 μm to about 25 μm. In alternative embodiments, the primer layer 14 can be formed by other thermoset paints and is solidified by UV or thermal curing reaction.

In the illustrated embodiment, the ink jet coating layer 16 is formed by ink-jet printing and is solidified by UV. A thickness of the ink jet coating layer 16 is in a range from about 4 μm to about 5 μm and the luminescence of the ink jet coating layer 16 is more than 85%.

In the illustrated embodiment, the protection layer 18 protects the primer layer 14 and the ink jet coating layer 16 from abrasion. The protection layer 18 has properties of high abrasion resistance, high water resistance, and high aging resistance. The protection layer 18 is formed by UV curing paint or thermoset paint. A thickness of the protection layer 18 is in a range from about 8 μm to about 20 μm.

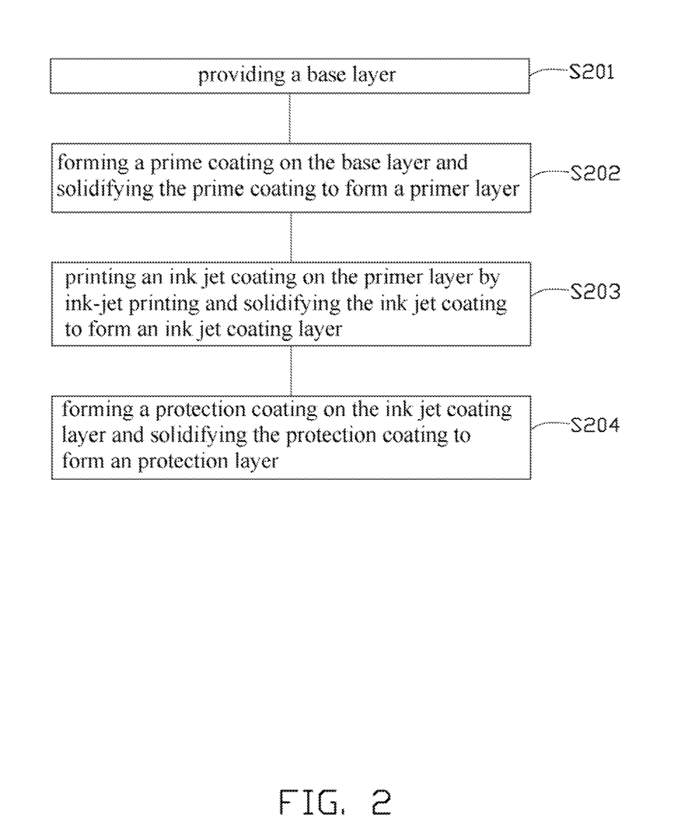

Referring to FIG. 2, an embodiment of a method for manufacturing a housing 10 is illustrated as follows.

In step S201: a base layer 12 is provided. In the illustrated embodiment, the base layer 12 is made of polyvinyl chloride. An outer surface of the base layer 12 to be painted is polished by sandblasting. The material for the base layer 12 can be selected from a group of magnesium alloy, titanium alloy, other suitable alloys and polymeric materials.

In alternative embodiments, the outer surface of the base layer 12 to be painted can be pretreated by washing, electrostatic dust removal or other pretreatment method to remove the dust, oil, or broken filaments from the surface of the base layer 12.

In step S202: a prime coating is coated on the base layer 12 and solidified, thereby forming the primer layer 14. In the illustrated embodiment, the primer layer 14 is a silver paint layer on the base layer 12 by spraying via spray gun. A thickness of the primer layer 14 is preferably in a range from about 15 μm to 25 μm.

In step S203: an ink jet coating is printed on the primer layer 14 by ink jet printing and solidified, thereby forming the ink jet coating layer 16. In the illustrated embodiment, an ink jet material composition for forming the ink jet coating layer 16 includes oligomer in a proportion by weight from 0.1 to 40%, monomer in a proportion by weight from 5 to 30%, pigment in a proportion by weight from 1 to 8%, photoinitiator in a proportion by weight from 2 to 10%, solvent in a proportion by weight from 30 to 70%, additives in a proportion by weight from 0.5 to 5%. The ink jet coating layer 16 is solidified by UV, a thickness of the ink jet coating layer 16 is from about 4 μm to 5 μm, and the luminescence of the ink jet coating layer 16 is more than 85%. Preferably, the ink jet material includes oligomer in a proportion by weight of 12%, monomer in a proportion by weight of 17.2%, pigment in a proportion by weight of 2.6%, photoinitiator in a proportion by weight of 2.7%, additive in a proportion by weight of 1%, and the balance being of solvent.

The oligomer can be polyurethane acrylate oligomer, epoxy acrylate oligomer, polyester acrylate oligomer, acrylic resin, acrylic ester or any suitable combination thereof.

The monomer can be a single-function monomer, bifunctional monomer, multifunctional monomer or any suitable combination thereof. The single-function monomer can be selected from 2-(2-Ethoxyethoxy)ethyl acrylate, (5-ethyl-1,3-dioxan-5-yl)methyl acrylate, isodecyl acrylate, or isobornyl acrylate. The bifunctional monomer can be selected from neopentyl glycol diacrylate, tri(propylene glycol) diacrylate, hexamethylene diacrylate, polyethylene glycol 200 diacrylate, propoxylated neopentyl glycol di-acrylate, or hydroxypivalyl hydroxypivalate diacrylate. The multifunctional monomer can be selected from trimethylolpropane triacrylate (TMPTA), isocyanuric acid Tris(2-acryloyloxyethyl) Ester, pentaerythritol triacrylate, ethoxylated trimethylolpropane triacrylate, propoxylated glyceryl triacrylate, trimethylolpropane trimethacrylate, pentaerythritol tetraacrylate, bistrimethylolpropanetetraacrylate, or dipentaerythritol pentaacrylate.

The photoinitiator can be selected from diphenyl(2,4,6-trimethylbenzoyl)phosphine oxide, 2-hydroxy-2-methylpropiophenone, 2-methyl-4′-(methylthio)-2-morpholinopropiophenone, 2-methyl-4′-(methylthio)-2-morpholinopropiophenone, 2-isopropylthioxanthone, benzophenone, 2,2-dimethoxy-2-phenylacetophenone, or ethyl 4-dimethylaminobenzoate.

The solvent can be selected from esters, alcohols, alcohol ethers, ketones, alcohol acid esters, or petroleum ether.

The additive can be selected from moistening agent, defoaming agent, or levelling agent.

In step S204: a protection coating is coated on the ink jet coating layer 16 and solidified, thereby forming a protection layer 18 on the outer surface of the housing 10. In the illustrated embodiment, the protection layer 18 is formed by spraying via spray gun. A thickness of the protection layer 18 is controlled to be in a range from about 1 μm to about 35 μm. The protection layer 18 has properties of high abrasion resistance, high water resistance and high aging resistance.

In an alternative embodiment, the primer layer 14 can be formed by ink-jet printing. The protection layer 18 can also be formed by ink-jet printing.

In an alternative embodiment, before the ink jet coating layer 16 is formed, a metal layer can be deposited on the surface of the primer layer 14 by vacuum metallization.

It is to be understood that since it is easy to control the thickness of the ink jet coating layer 16 by ink-jet printing, a patterned or a multi-colored coating can be formed on the housing 10.

It is believed that the present embodiments and their advantages will be understood from the foregoing description, and it will be apparent that various changes may be made thereto without departing from the spirit and scope of the embodiments or sacrificing all of its material advantages.

1. A housing, comprising:
a base layer;
a primer layer formed on the base layer;
an ink jet coating layer formed on the primer layer; and
a protection layer formed on the ink jet coating layer.

2. The housing of claim 1, wherein the base layer is selected from a group consisting of aluminum alloy, magnesium alloy and titanium alloy.

3. The housing of claim 1, wherein the base layer is selected from a group consisting of polyvinyl chloride, polyethylene terephthalate, acrylonitrile-butadiene-styrene copolymer, polycarbonate, polyimide, multi-hydroxyl polymer, amine polymer, epoxy-based polymer, polyetherimide, polyphenylene sulfide, poly sulfone, polyvinyl propylene, polystyrene, polyethylene glycol modified polyester, polypropylene copolymer, and a combination thereof.

4. The housing of claim 1, wherein a thickness of the primer layer is selected from the range from about 15 μm to about 25 μm.

5. The housing of claim 1, wherein a thickness of the ink jet coating layer is less than 15 μm.

6. The housing of claim 5, wherein a thickness of the ink jet coating layer is between a range from about 4 μm to about 5 μm, and the luminescence of the ink jet coating layer is more than 85%.

7. A method for manufacturing a housing, comprising:
providing a base layer;
forming a prime coating on the base layer and solidifying the prime coating to form a primer layer;
printing an ink jet coating on the primer layer by ink-jet printing and solidifying the ink jet coating to form an ink jet coating layer; and
forming a protection coating on the ink jet coating layer and solidifying the protection coating to form a protection layer.

8. The method of claim 7, wherein the base layer is selected from the group consisting of aluminum alloy, magnesium alloy and titanium alloy.

9. The method of claim 7, wherein the base layer is selected from the group consisting of polyvinyl chloride, polyethylene terephthalate, acrylonitrile-butadiene-styrene copolymer, polycarbonate, polyimide, multi-hydroxyl polymer, amine polymer, epoxy-based polymer, polyetherimide, polyphenylene sulfide, poly sulfone, polyvinyl propylene, polystyrene, polyethylene glycol modified polyester, polypropylene copolymer, and a combination thereof.

10. The method of claim 7, wherein the surface of the base is pretreated by washing, electrostatic dust removal or other pretreatment method to remove the dust, oil, or broken filament from the surface of the base layer.

11. The method of claim 7, wherein the primer layer is a silver paint layer formed on the base layer by spraying via a spray gun, and a thickness of the primer layer is in a range from about 15 μm to about 25 μm.

12. The method of claim 7, wherein an ink jet material composition for forming the ink jet coating layer comprises an oligomer in a proportion by weight from 0.1 to 40%, a monomer in a proportion by weight from 5 to 30%, a pigment in a proportion by weight from 1 to 8%, a photoinitiator in a proportion by weight from 2 to 10%, a solvent in a proportion by weight from 30 to 70%, and one or more additives in a proportion by weight from 0.5 to 5%.

13. The method of claim 12, wherein the ink jet material composition comprises an oligomer in a proportion by weight of 12%, a monomer in a proportion by weight of 17.2%, a pigment in a proportion by weight 2.6%, a photoinitiator in a proportion by weight of 2.7%, one or more additive in a proportion by weight of 1%, and the balance being of solvent.

14. The method of claim 12, wherein the ink jet coating layer is solidified by UV, a thickness of the ink jet coating layer is selected from a range from about 4 μm to about 5 μm, and the luminescence of the ink jet coating layer is more than 85%.

15. The method of claim 12, wherein the monomer is selected from the group consisting of single-function monomer, bifunctional monomer, multifunctional monomer or a combination thereof; the single-function monomer is selected from 2-(2-Ethoxyethoxy)ethyl acrylate, (5-ethyl-1,3-dioxan-5-yl)methyl acrylate, isodecyl acrylate, and isobornyl acrylate; the bifunctional monomer is selected from neopentyl glycol diacrylate, tri(propylene glycol) diacrylate, hexamethylene diacrylate, polyethylene glycol 200 diacrylate, propoxylated neopentyl glycol di-acrylate, and hydroxypivalyl hydroxypivalate diacrylate; the multifunctional monomer is selected from trimethylolpropane triacrylate (TMPTA), isocyanuric acid Tris(2-acryloyloxyethyl) Ester, pentaerythritol triacrylate, ethoxylated trimethylolpropane triacrylate, propoxylated glyceryl triacrylate, trimethylolpropane trimethacrylate, pentaerythritol tetraacrylate, bistrimethylolpropanetetraacrylate, dipentaerythritol pentaacrylate, and a combination thereof.

16. The method of claim 12, wherein the photoinitiator is selected from the group consisting of diphenyl(2,4,6-trimethylbenzoyl)phosphine oxide, 2-hydroxy-2-methylpropiophenone, 2-methyl-4′-(methylthio)-2-morpholinopropiophenone, 2-methyl-4′-(methylthio)-2-morpholinopropiophenone, 2-isopropylthioxanthone, benzophenone, 2,2-dimethoxy-2-phenylacetophenone, ethyl 4-dimethylaminobenzoate, and a combination thereof.

17. The method of claim 12, wherein the solvent is selected from the group consisting of esters, alcohols, alcohol ethers, ketones, alcohol acid esters, petroleum ether, and a combination thereof the additive is selected from the group consisting of moistening agent, defoaming agent, levelling agent, and a combination thereof.
